(19) United States
(12) Patent Application Publication
(10) Pub. No.: US 2026/0016408 A1
(43) Pub. Date: Jan. 15, 2026

(54) Gas Absorption Spectroscopy Apparatus, Non-Transitory Computer Readable Medium, And Control Method

(71) Applicant: SHIMADZU CORPORATION, Kyoto-shi (JP)

(72) Inventor: Kazune MANO, Kyoto-shi (JP)

(21) Appl. No.: 19/268,285

(22) Filed: Jul. 14, 2025

(30) Foreign Application Priority Data
Jul. 12, 2024 (JP) 2024-112675

(51) Int. Cl. G01N 21/39; G02F 1/11

(52) U.S. Cl. CPC G01N 21/39; G02F 1/113

(57) ABSTRACT

A gas absorption spectroscopy apparatus analyzes a sample. The gas absorption spectroscopy apparatus includes a resonator that stores the sample, a light source that outputs a laser beam to the resonator, an acousto-optic modulator that is disposed on an optical path between the light source and the resonator and modulates a frequency of the laser beam according to a frequency of an input signal, a photodetector that detects light output from the resonator, and a controller. The controller changes the frequency of the input signal to bring the laser beam in the resonator into a non-resonant state, and measures a target component in the sample using a signal detected by the photodetector while the laser beam in the resonator is in the non-resonant state.

### BACKGROUND OF THE INVENTION

### FIELD OF THE INVENTION

The present disclosure relates to a gas absorption spectroscopy apparatus, a non-transitory computer readable medium, and a control method.

### DESCRIPTION OF THE RELATED ART

As described in Non-Patent Literature 1, Cavity Ring-Down Spectroscopy (CRDS) is known as a type of gas absorption spectroscopy. CRDS is a spectroscopic technique that measures the concentration of a target component in a gas within a resonator with high sensitivity by effectively lengthening the optical path length using a resonator (cavity).

In CRDS, a laser beam is input from a light source into a resonator. The laser beam input into the resonator is accumulated in the resonator. After the laser beam is sufficiently accumulated in the resonator, the input of the laser beam to the resonator is blocked. Thereafter, the decay of the light leaking from the resonator is measured. The gas absorption spectroscopy apparatus acquires the output signal of a photodetector as a "ring- down signaL." The gas absorption spectroscopy apparatus measures the concentration of a target component contained in the gas within the resonator by calculating the decay time constant of the light (ring-down time) using the acquired ring-down signal.

Such a gas absorption spectroscopy apparatus may include an Acousto-Optic Modulator (AOM) between the resonator and the light source to block the input of the laser beam to the resonator. When an RF signal of an appropriate frequency is input to the AOM, diffracted light is generated. By stopping the input of the RF signal to the AOM, the laser path is switched, and the laser beam to the resonator is blocked.

### PRIOR ART DOCUMENTS

### Non-Patent Literature

[Non-Patent Literature 1] Kazune Mano, "Development of Cavity Ring-Down Spectrometer for Radiocarbon (14C) Isotopes," Shimadzu Review, Vol. 78, pp. 255-264 (2021)

### SUMMARY OF THE INVENTION

### Problem to be Solved by the Invention

However, even when the input of the RF signal to the AOM is stopped, a slight amount of diffracted light may be generated, causing a part of the laser beam to pass through the AOM, which may prevent the ring-down time from being calculated accurately. Therefore, to block the laser beam more reliably at the AOM, the gas absorption analysis apparatus may be equipped with multiple AOMs or an optical path in which the laser beam passes through a single AOM multiple times, which may complicate the circuit configuration of the gas absorption analysis apparatus.

The present disclosure has been made to solve the above-described problems, and an object thereof is to provide a technology capable of blocking a laser beam output to a resonator while suppressing an influence on the calculation of the ring-down time.

### Means for Solving the Problem

A gas absorption spectroscopy apparatus according to an aspect of the present disclosure is an apparatus for analyzing a sample. The apparatus includes a resonator for storing the sample, a light source for outputting a laser beam to the resonator, an acousto-optic modulator disposed on an optical path between the light source and the resonator for modulating a frequency of the laser beam according to a frequency of an input signal, a photodetector for detecting light output from the resonator, and a controller for controlling the acousto-optic modulator. The controller changes the frequency of the input signal to bring the laser beam in the resonator into a non-resonant state, and measures a target component in the sample using a signal detected by the photodetector while the laser beam in the resonator is in the non-resonant state.

A non-transitory computer readable medium according to an aspect of the present disclosure is the non-transitory computer readable medium where a control program is stored, the control program being to be executed by a computer that is for use in a gas absorption spectroscopy apparatus that analyzes a sample. The gas absorption spectroscopy apparatus includes a resonator for storing the sample, a light source for outputting a laser beam to the resonator, an acousto-optic modulator disposed on an optical path between the light source and the resonator for modulating a frequency of the laser beam according to a frequency of an input signal, and a photodetector for detecting light output from the resonator. The control program causes the computer to execute the steps of changing the frequency of the input signal to bring the laser beam in the resonator into a non-resonant state, and measuring a target component in the sample using a signal detected by the photodetector while the laser beam in the resonator is in the non-resonant state.

A control method according to an aspect of the present disclosure is a control method for use in a gas absorption spectroscopy apparatus that analyzes a sample. The gas absorption spectroscopy apparatus includes a resonator for storing the sample, a light source for outputting a laser beam to the resonator, an acousto-optic modulator disposed on an optical path between the light source and the resonator for modulating a frequency of the laser beam according to a frequency of an input signal, and a photodetector for detecting light output from the resonator. The control method includes, as processing executed by a computer, the steps of changing the frequency of the input signal to bring the laser beam in the resonator into a non-resonant state, and measuring a target component in the sample using a signal detected by the photodetector while the laser beam in the resonator is in the non-resonant state.

### Effect of the Invention

According to the present disclosure, it is possible to block the laser beam output to the resonator while suppressing the influence on the calculation of the ring-down time.

### BRIEF DESCRIPTION OF THE DRAWINGS

FIG. 1 is a diagram schematically showing a configuration of a gas absorption spectroscopy apparatus according to the present embodiment.

FIG. 2 is a conceptual diagram for explaining mode frequencies.

FIG. 3 is a diagram showing the relationship between the transmission intensity of a CRDS resonator and the laser frequency.

FIG. 4 is a functional block diagram of the gas absorption spectroscopy apparatus according to the present embodiment.

FIG. 5 is a flowchart showing a process for blocking the laser beam output to the CRDS resonator for acquiring a ring-down signal in the present embodiment.

FIG. 6 is a functional block diagram of a gas absorption spectroscopy apparatus according to a comparative example.

FIG. 7 is a flowchart showing a process for blocking the laser beam output to the CRDS resonator for acquiring a ring-down signal in the comparative example.

### DETAILED DESCRIPTION OF THE PREFERRED EMBODIMENTS

Hereinafter, the present embodiment will be described in detail with reference to the drawings. In the following description, the same or corresponding parts in the drawings are denoted by the same reference numerals, and a description thereof will not be repeated.

### Configuration of Gas Absorption Spectroscopy Apparatus

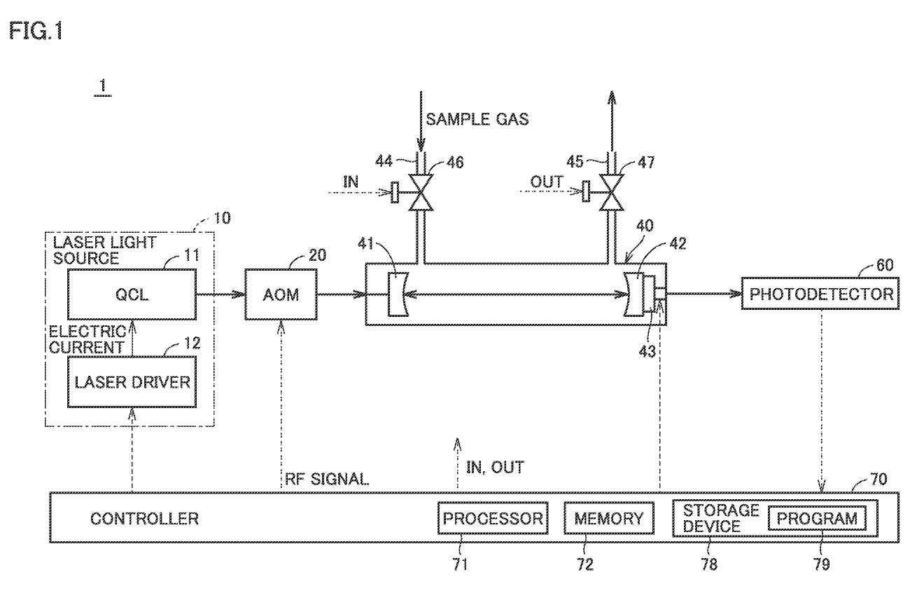

FIG. 1 is a diagram schematically showing a configuration of a gas absorption spectroscopy apparatus 1 according to the present embodiment. The gas absorption spectroscopy apparatus 1 includes a laser light source 10, an AOM (Acousto-Optic Modulator) 20, a CRDS resonator 40, a photodetector (PD) 60, and a controller 70.

The laser light source 10 includes a measurement QCL (Quantum Cascade Laser) 11 and a laser driver 12. The measurement QCL 11 outputs a laser beam to the resonator 40. The measurement QCL 11 is configured to vary the oscillation frequency of the laser beam based on a current applied from the laser driver 12. Specifically, the measurement QCL 11 is a distributed feedback quantum cascade laser (QCL). The measurement QCL 11 is an example of a "light source" in the present disclosure.

The AOM 20 is provided on the optical path between the measurement QCL 11 and the CRDS resonator 40. The AOM 20 is an example of an "acousto-optic modulator" in the present disclosure. The AOM 20 can switch between outputting and blocking the laser beam from the measurement QCL 11 to the CRDS resonator 40 at high speed.

The AOM 20 enters an ON state to output the laser beam from the measurement QCL 11 to the CRDS resonator 40 when an RF (Radio Frequency) signal having a predetermined frequency is applied from the controller 70. The AOM 20 enters an OFF state, not outputting the laser beam from the measurement QCL 11 to the CRDS resonator 40, when the application of the RF signal from the controller 70 is stopped.

Furthermore, the AOM 20 in the present embodiment modulates the frequency of the laser beam. The AOM 20 changes the frequency of the laser beam output from the AOM 20 to the CRDS resonator 40 according to the frequency of the RF signal. More specifically, the frequency of the laser beam after being modulated by the AOM 20 is a value obtained by adding the frequency of the RF signal to the frequency of the laser beam output from the measurement QCL 11.

The CRDS resonator 40 is provided on the optical path between the AOM 20 and the photodetector 60. The CRDS resonator 40 is an example of a "resonator" in the present disclosure. The CRDS resonator 40 is configured to include a container (cell) capable of storing a sample gas, and has an introduction pipe 44 for introducing the sample gas into the interior before the start of measurement, and an exhaust pipe 45 for discharging the sample gas to the outside after the end of measurement. The introduction pipe 44 is provided with an introduction valve 46. The exhaust pipe 45 is provided with an exhaust valve 47. The controller 70 controls the opening and closing of the introduction valve 46 and the exhaust valve 47.

Inside the CRDS resonator 40, a pair of mirrors 41 and 42 is provided. The mirrors 41 and 42 are arranged opposite each other so that light reflects between them inside the CRDS resonator 40. Concave mirrors are used for the mirrors 41 and 42 to easily satisfy the stability condition of the CRDS resonator 40. Also, high-reflectivity (e.g., about 99.9%) mirrors are used for the mirrors 41 and 42 so that the light leaking to the outside of the CRDS resonator 40 is extremely weak. The number of mirrors arranged inside the CRDS resonator 40 is not limited to two and may be three or more. That is, it may be a resonator in which mirrors are arranged so that light reflects between them, or a resonator in which mirrors are arranged in a ring shape so that light reflects in one direction.

A piezoelectric element 43 is arranged on the mirror 42. The piezoelectric element 43 displaces the mirror 42 in the optical axis direction by driving the mirror 42 constituting the CRDS resonator 40 in accordance with a command from the controller 70. This changes the resonator length of the CRDS resonator 40. A piezoelectric element may be arranged on the mirror 41 instead of the mirror 42, or piezoelectric elements may be arranged on both the mirror 41 and the mirror 42.

The photodetector 60 is, for example, a photodiode. The photodetector 60 detects the weak light extracted from the mirror 42 of the CRDS resonator 40 as the output light of the CRDS resonator 40 and outputs a detection signal to the controller 70. For example, a liquid nitrogen-cooled InSb (Indium Antimonide) detector can be used as the photodetector 60.

The controller 70 includes a processor 71 such as a CPU (Central Processing Unit) or an FPGA (Field-Programmable Gate Array), a memory 72 such as a ROM (Read Only Memory) and a RAM (Random Access Memory), a storage device 78, and an input/output port (not shown).

The storage device 78 stores various programs executed by the processor 71, various data, and the like. The storage device 78 may be one or more non-transitory computer-readable media or one or more computer-readable storage media. Examples of the storage device 78 include a flash memory, an HDD (Hard Disk Drive), and an SSD (Solid State Drive).

The storage device 78 according to Embodiment 1 stores a control program 79. The control program 79 is a program for performing light blocking by controlling the AOM 20, which will be described later.

The controller 70 controls each device constituting the gas absorption spectroscopy apparatus 1. Specifically, the controller 70 outputs a command for scanning the oscillation frequency of the laser beam to the laser driver 12, and outputs the above-mentioned RF signal to the AOM 20. Further, the controller 70 outputs a command for introducing the sample gas into the CRDS resonator 40 to the introduction valve 46, and outputs a command for discharging the sample gas to the outside of the CRDS resonator 40 to the exhaust valve 47.

The controller 70 applies a voltage for displacing the mirror 42 to the piezoelectric element 43. The controller 70 executes various data processing. The various data processing includes a process of calculating the concentration (absolute concentration) of the target component contained in the sample gas based on the detection signal from the photodetector 60.

The controller 70 may be divided into two or more units for each function. For example, the controller 70 may be divided into a unit that controls each device and a unit that executes various data processing.

### Measurement Principle by Cavity Ring-Down Spectroscopy (CRDS)

The measurement principle by the cavity ring-down absorption spectroscopy in the gas absorption spectroscopy apparatus 1 will be described. Generally, when the frequency of light irradiated onto a resonator is a specific frequency, resonance occurs in the resonator. Hereinafter, the frequency of the laser beam input to the CRDS resonator 40 is referred to as "laser frequency," and the frequency of light at which resonance can occur in the CRDS resonator 40 is referred to as "mode frequency."

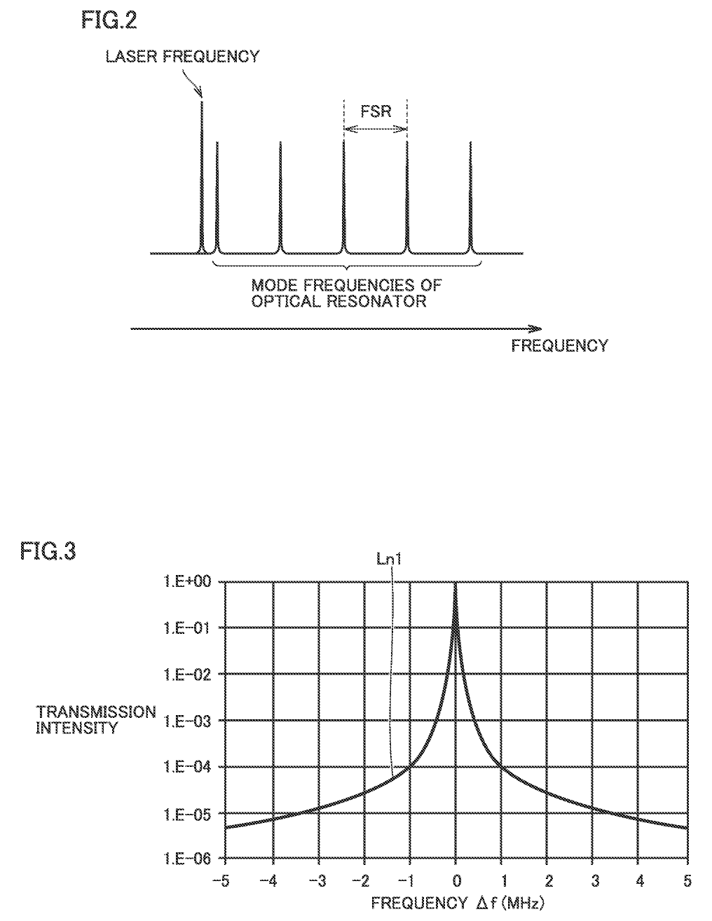

FIG. 2 is a conceptual diagram for explaining the mode frequency. As shown in FIG. 2, there are a plurality of mode frequencies at predetermined frequency intervals. Hereinafter, the interval between two adjacent mode frequencies among the plurality of mode frequencies is referred to as "Free Spectral Range" (FSR).

If the laser frequency does not coincide with any of the mode frequencies, the power of the light is not stored in the CRDS resonator 40. On the other hand, if the laser frequency coincides with any of the mode frequencies, the power of the light is stored in the CRDS resonator 40.

The controller 70 determines whether the power of the laser beam has been sufficiently accumulated in the CRDS resonator 40 based on the output signal of the photodetector 60. When the controller 70 determines that the power of the laser beam has been sufficiently accumulated in the CRDS resonator 40, it controls the AOM 20 to block the output of the laser beam to the CRDS resonator 40. The control method for the AOM 20 will be described later.

Then, the light accumulated in the CRDS resonator 40 travels back and forth between the mirror 41 and the mirror 42 a large number of times (usually several thousand to tens of thousands of times). This light gradually decays as it travels back and forth between the mirrors 41 and 42 due to losses from reflection leakage of the mirrors 41 and 42 and absorption by the target component in the sample gas. Therefore, the output light of the CRDS resonator 40 leaking from the mirror 42 gradually decays. In CRDS, by lengthening the distance that the light passes through the sample gas (effective optical path length) using the CRDS resonator 40, the light absorption can be detected even if the light absorption by the target component is extremely small.

The controller 70 acquires a signal detected by the photodetector 60 while the light input to the CRDS resonator 40 is blocked as a "ring-down signal." The controller 70 calculates the decay time constant of the acquired ring-down signal as the "ring-down time." The controller 70 calculates the concentration of the target component contained in the sample gas from the calculated ring-down time.

### Transmission Intensity

FIG. 3 is a diagram showing the relationship between the transmission intensity of the CRDS resonator 40 and the laser frequency. FIG. 3 shows a line Ln1 indicating the transmission intensity of the CRDS resonator 40 with respect to a specific resonant frequency.

The vertical axis indicates the transmission intensity of the CRDS resonator 40. The transmission intensity is an index indicating the degree to which the laser beam output from the AOM 20 is transmitted to the photodetector 60 in the CRDS resonator 40. When the transmission intensity is high, the intensity of the laser beam detected by the photodetector 60 becomes large, and when the transmission intensity is low, the intensity of the laser beam detected by the photodetector 60 becomes small.

The horizontal axis indicates the frequency of the laser beam input to the CRDS resonator 40. More specifically, the horizontal axis shows the frequency normalized with the resonant frequency of the CRDS resonator 40 as "0". That is, the horizontal axis indicates how far the laser frequency output to the CRDS resonator 40 is from a specific resonant frequency. The frequency Af is a value indicating the difference from the specific resonant frequency. When the frequency Af is "0 MHz," the frequency of the laser beam output to the CRDS resonator 40 is the resonant frequency.

As shown in FIG. 3, when the laser frequency of the laser beam input to the CRDS resonator 40 is the resonant frequency, the transmission intensity of the CRDS resonator 40 is the highest. On the other hand, as the difference between the laser frequency of the laser beam input to the CRDS resonator 40 and the resonant frequency becomes larger, the transmission intensity of the CRDS resonator 40 becomes smaller.

### Functional Block Diagram of Overall Configuration

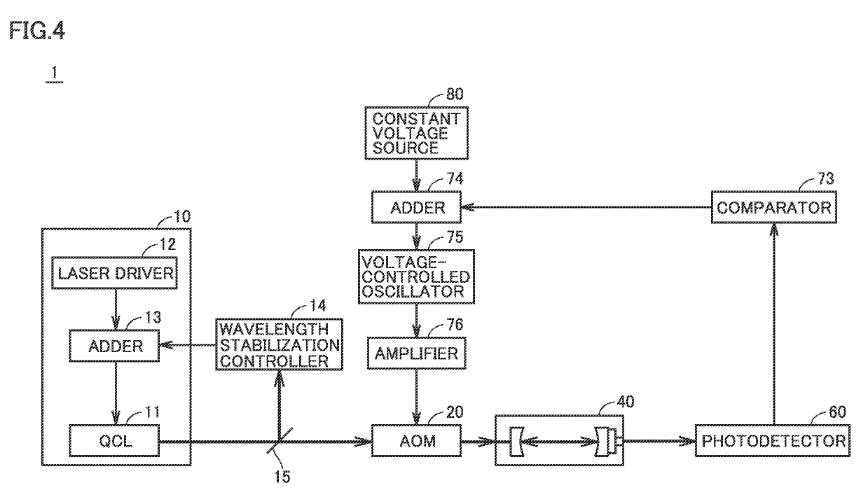

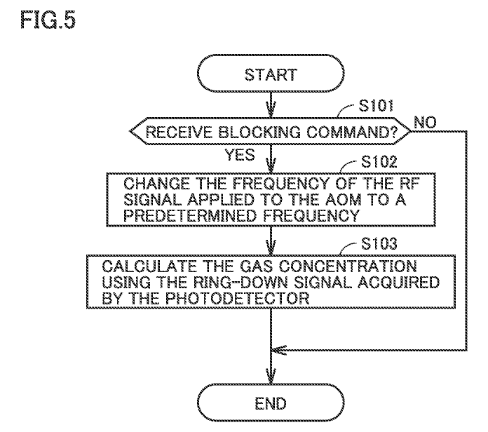

FIG. 4 is a functional block diagram of the gas absorption spectroscopy apparatus 1 in the present embodiment. As shown in FIG. 4, a beam splitter 15 is disposed between the measurement QCL 11 and the AOM 20.The laser beam output from the measurement QCL 11 is split by the beam splitter 15 into a direction toward the AOM 20 and a direction toward a wavelength stabilization controller 14.

The wavelength stabilization controller 14 detects the laser beam output from the measurement QCL 11 and transmits a signal to an adder 13 based on the detected laser beam. The adder 13 adjusts the frequency of the laser beam output from the measurement QCL 11 using the signal received from the wavelength stabilization controller 14. Thereby, the frequency of the laser beam output from the measurement QCL 11 is maintained at a desired frequency.

Further, as shown in FIG. 4, the output signal of the photodetector 60 is output to a comparator 73. The comparator 73 is a comparator for comparing whether or not the power of the laser beam in the CRDS resonator 40 is in a sufficiently accumulated state. The comparator 73 outputs a result indicating whether or not the power of the laser beam in the CRDS resonator 40 is in a sufficiently accumulated state to an adder 74.

A constant voltage source 80 supplies a voltage for generating an RF signal to be output to the AOM 20. The adder 74 controls a voltage-controlled oscillator 75 based on the output result from the comparator 73. The voltage-controlled oscillator 75 adjusts the frequency of the RF signal. That is, the value of the frequency Af in FIG. 3 is adjusted by the voltage-controlled oscillator 75. An amplifier 76 amplifies the RF signal whose frequency has been adjusted by the voltage-controlled oscillator 75.

In the present embodiment, when the adder 74 receives from the comparator 73 a result indicating that the power of the laser beam in the CRDS resonator 40 is in a sufficiently accumulated state, the adder 74 changes the frequency of the RF signal adjusted by the voltage-controlled oscillator 75. The controller 70 in FIG. 1 may include at least one of the adder 74, the comparator 73, and the voltage-controlled oscillator 75 in FIG. 4. Each of the adder 74, the comparator 73, and the voltage-controlled oscillator 75 may be realized by the processor 71 performing processing.

FIG. 5 is a flowchart showing a process for blocking the laser beam output to the CRDS resonator 40 for acquiring a ring-down signal in the present embodiment. The flowchart shown in FIG. 5 is realized by the processor 71 executing the control program 79.

The processor 71 determines whether a blocking command has been received (step S101). In the present embodiment, the blocking command is a command requesting the blocking of the output of the laser beam to the CRDS resonator 40, and is output based on the fact that the power of the laser beam in the CRDS resonator 40 is in a sufficiently accumulated state. In step S101, a laser beam having a resonant frequency is output from the AOM 20 to the CRDS resonator 40. That is, using the example of FIG. 3, the frequency Af of the laser beam input to the CRDS resonator 40 in step S101 is "0 MHz".

If the processor 71 does not receive the blocking command (NO in step S101), the process ends. If the processor 71 receives the blocking command (YES in step S101), it changes the frequency of the RF signal applied to the AOM 20 from the resonant frequency to a predetermined frequency (step S102). For example, the processor 71 adjusts the absolute value of the frequency Af to be "5" or more. As a result, as shown in FIG. 3, the transmission intensity of the CRDS resonator 40 becomes small. That is, the output of the laser beam to the CRDS resonator 40 is blocked. After the output of the laser beam to the CRDS resonator 40 is blocked, the processor 71 calculates the concentration of the target component contained in the sample gas using the ring-down signal acquired by the photodetector 60 (step S103). The shift amount of the frequency changed in step S102 is not limited to 5 MHz, and may be, for example, 2 MHz, 3 MHz, or 5 MHz or more.

As described above, the gas absorption spectroscopy apparatus 1 of the present embodiment reduces the transmission intensity of the CRDS resonator 40 by changing the frequency of the RF signal input to the AOM 20, thereby blocking the output of the laser beam to the CRDS resonator 40.

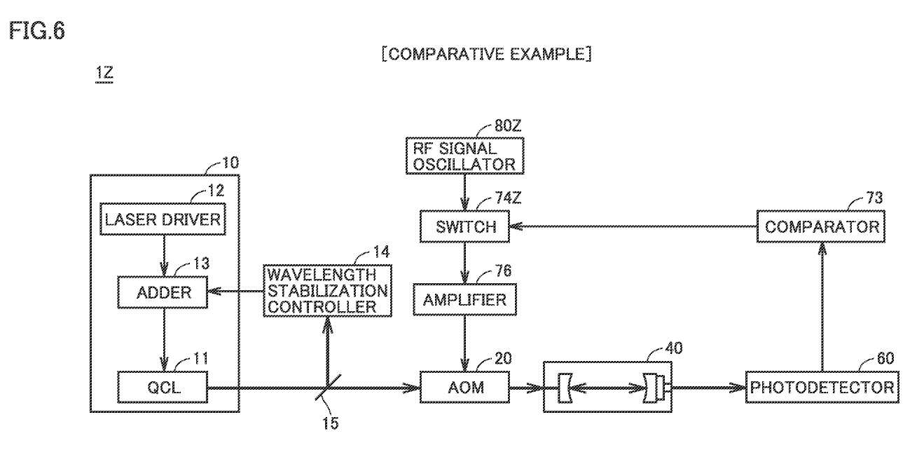

Hereinafter, a comparative example will be described. FIG. 6 is a functional block diagram of a gas absorption spectroscopy apparatus 1Z according to a comparative example. As shown in FIG. 6, the comparator 73 outputs a result indicating whether or not the power of the laser beam in the CRDS resonator 40 is in a sufficiently accumulated state to a switch 74Z.

An RF signal oscillator 80Z generates an RF signal and supplies it to the AOM 20. When the switch 74Z is in an ON state, it outputs the RF signal generated by the RF signal oscillator 80Z to the AOM 20 via the amplifier 76. When the switch 74Z is in an OFF state, it does not output the RF signal generated by the RF signal oscillator 80Z to the AOM 20 via the amplifier 76. The switch 74Z is configured to be in the OFF state when it receives a result from the comparator 73 indicating that the power of the laser beam in the CRDS resonator 40 is in a sufficiently accumulated state.

When the switch 74Z is turned to the OFF state, no RF signal is output to the AOM 20. As a result, the laser beam output from the measurement QCL 11 is output from the AOM 20 on an optical path different from the optical path toward the CRDS resonator 40. In other words, the output of the laser beam to the CRDS resonator 40 is blocked.

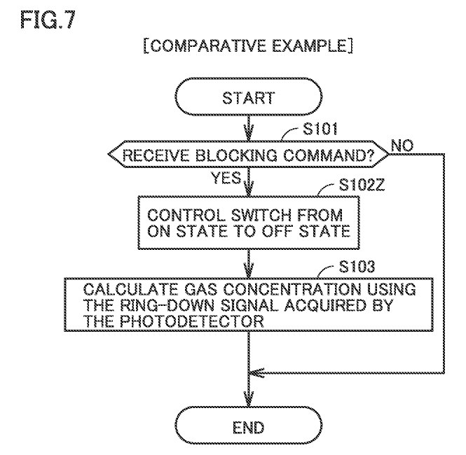

FIG. 7 is a flowchart showing a process for blocking the laser beam output to the CRDS resonator 40 for acquiring a ring-down signal in the comparative example. The flowchart of FIG. 7 is the same as the flowchart of FIG. 5 except for the process of step 102.

When the processor 71 receives the blocking command (YES in step S101), it controls the state of the switch 74Z from the ON state to the OFF state (step S102Z). As a result, the laser beam output from the measurement QCL 11 is output from the AOM 20 on an optical path different from the optical path toward the CRDS resonator 40. In other words, the output of the laser beam to the CRDS resonator 40 is blocked. However, in the gas absorption spectroscopy apparatus 1Z of the comparative example, even when the input of the RF signal is stopped, a slight amount of diffracted light may be generated, causing a part of the laser beam to pass through the AOM, which may prevent the ring-down time from being calculated accurately.

That is, in the gas absorption spectroscopy apparatus 1 of the comparative example, if the blocking of the RF signal by the switch 74Z is not sufficient, the laser beam at the resonant frequency with the highest transmission intensity is output to the CRDS resonator 40. As a result, the photodetector 60 detects unintended laser light during the acquisition period of the ring-down signal, and the ring-down time cannot be calculated accurately.

On the other hand, in the gas absorption spectroscopy apparatus 1 of the present embodiment, the output of the laser beam to the CRDS resonator 40 is blocked by changing the frequency of the RF signal input to the AOM 20. Therefore, even when a laser beam is output from the AOM 20 to the CRDS resonator 40, a laser beam with a lower transmission intensity compared to the resonant frequency is output to the CRDS resonator 40. As a result, in the present embodiment, during the period when the photodetector 60 acquires the ring-down signal, the laser beam at the resonant frequency with the highest transmission intensity is not output to the photodetector 60. That is, in the present embodiment, it is possible to block the laser beam output to the CRDS resonator 40 while suppressing the influence on the calculation of the ring-down time.

### Modifications

In the gas absorption spectroscopy apparatus 1 of Embodiment 1, an example has been described in which the processor 71 has an arithmetic processing unit such as a CPU. However, the processor 71 may be configured according to a dedicated hardware circuit for the gas absorption spectroscopy apparatus 1. Further, in the example of FIG. 1, a configuration with a single processor is illustrated, but the gas absorption spectroscopy apparatus 1 may have a plurality of processors.

The processor 71 is a processing entity (computer) that executes various processes according to various programs. The processor 71 may be composed of, for example, at least one of a CPU, an MPU, and a GPU (Graphics Processing Unit). The processor 71 has a function of executing various processes by executing a program, but a part or all of these functions may be an application-specific integrated circuit (ASIC) or the like. The processor 71 may be configured with a processing circuitry.

In the present disclosure, the term "processor" is not limited to a processor in a narrow sense that executes processing by a stored program method, such as a CPU or an MPU, but may include a hard-wired circuit such as an ASIC or an FPGA. Therefore, the processor 71 can also be read as a processing circuitry in which processing is predefined by computer-readable code and/or a hard-wired circuit.

The processor 71 may be configured with a single chip or a plurality of chips. Furthermore, the processor 71 and related processing circuits may be configured by a plurality of computers interconnected wiredly or wirelessly via a local area network or a wireless network. The processor 71 and related processing circuits may be configured as a cloud computer that performs calculations remotely based on input data and outputs the calculation results to other devices at a remote location.

Furthermore, in the above example, it has been described that the storage device 78 is an HD, SSD, or the like. However, the storage device 78 may be any format that can be read by the processor 71, which is a type of computer, as long as it can non-transitorily record a program. For example, the storage device 78 may be a CD-ROM (Compact Disc - Read Only Memory), DVD-ROM (Digital Versatile Disk - Read Only Memory), USB (Universal Serial Bus) memory, memory card, FD (Flexible Disk), hard disk, magnetic tape, cassette tape, MO (Magnetic Optical Disc), MD (Mini Disc), IC (Integrated Circuit) card (excluding memory cards), optical card, mask ROM, or EPROM.

### Aspects

It will be understood by those skilled in the art that the plurality of exemplary embodiments described above are specific examples of the following aspects.

(Item 1) A gas absorption spectroscopy apparatus according to one aspect is an apparatus for analyzing a sample. The gas absorption spectroscopy apparatus includes a resonator for storing the sample, a light source for outputting a laser beam to the resonator, an acousto-optic modulator disposed on an optical path between the light source and the resonator for modulating a frequency of the laser beam according to a frequency of an input signal, a photodetector for detecting light output from the resonator, and a controller for controlling the acousto-optic modulator. The controller changes the frequency of the input signal to bring the laser beam in the resonator into a non-resonant state, and measures a target component in the sample using a signal detected by the photodetector while the laser beam in the resonator is in the non-resonant state.

According to the gas absorption spectroscopy apparatus 1 described in Item 1, it is possible to block the laser beam output to the CRDS resonator 40 while suppressing the influence on the calculation of the ring-down time.

(Item 2) In the gas absorption spectroscopy apparatus according to Item 1, the resonator includes a plurality of mirrors and a piezoelectric element. The controller applies a voltage to the piezoelectric element to displace the positions of the plurality of mirrors.

According to the gas absorption spectroscopy apparatus 1 described in Item 2, the positions of the mirrors of the resonator can be adjusted using the piezoelectric element.

(Item 3) A non-transitory computer readable medium according to one aspect is a non- transitory computer readable medium where a control program is stored, the control program being to be executed by a computer that is for use in a gas absorption spectroscopy apparatus that analyzes a sample. The gas absorption spectroscopy apparatus includes a resonator for storing the sample, a light source for outputting a laser beam to the resonator, an acousto-optic modulator disposed on an optical path between the light source and the resonator for modulating a frequency of the laser beam according to a frequency of an input signal, and a photodetector for detecting light output from the resonator. The control program causes the computer to execute the steps of changing the frequency of the input signal to bring the laser beam in the resonator into a non-resonant state, and measuring a target component in the sample using a signal detected by the photodetector while the laser beam in the resonator is in the non-resonant state.

According to the control program described in Item 3, it is possible to block the laser beam output to the CRDS resonator 40 while suppressing the influence on the calculation of the ring-down time.

(Item 4) A control method according to one aspect is a control method for use in a gas absorption spectroscopy apparatus that analyzes a sample. The gas absorption spectroscopy apparatus includes a resonator for storing the sample, a light source for outputting a laser beam to the resonator, an acousto-optic modulator disposed on an optical path between the light source and the resonator for modulating a frequency of the laser beam according to a frequency of an input signal, and a photodetector for detecting light output from the resonator. The control method includes, as processing executed by a computer, the steps of changing the frequency of the input signal to bring the laser beam in the resonator into a non-resonant state, and measuring a target component in the sample using a signal detected by the photodetector while the laser beam in the resonator is in the non-resonant state.

According to the control method described in Item 4, it is possible to block the laser beam output to the CRDS resonator 40 while suppressing the influence on the calculation of the ring-down time.

The embodiments disclosed herein should be considered in all respects as illustrative and not restrictive. At least two of the embodiments disclosed herein may be combined as long as they are not contradictory. The basic scope of the present disclosure is indicated not by the above description but by the scope of claims for utility model registration, and is intended to include all modifications within the meaning and scope equivalent to the scope of claims for utility model registration.

### REFERENCE SIGNS LIST

1 Gas absorption spectroscopy apparatus

10 Laser light source

11 Measurement QCL

12 Laser driver

13, 74 Adder

14 Wavelength stabilization controller

15 Beam splitter

20 AOM

40 CRDS resonator

41, 42 Mirror

43 Piezoelectric element

44 Introduction pipe

45 Exhaust pipe

46 Introduction valve

47 Exhaust valve

60 Photodetector

70 Controller

71 Processor

72 Memory

73 Comparator

74Z Switch Voltage-controlled oscillator

76 Amplifier

78 Storage device

79 Control program

80 Constant voltage source

80Z RF signal oscillator

Ln1 Line

1. A gas absorption spectroscopy apparatus for analyzing a sample, the apparatus comprising:
a resonator configured to store the sample;
a light source configured to output a laser beam to the resonator;
an acousto-optic modulator disposed on an optical path between the light source and the resonator and configured to modulate a frequency of the laser beam according to a frequency of an input signal;
a photodetector configured to detect light output from the resonator; and a controller configured to control the acousto-optic modulator, wherein the controller is configured to:
change the frequency of the input signal to bring the laser beam in the resonator into a non-resonant state; and
measure a target component in the sample using a signal detected by the photodetector while the laser beam in the resonator is in the non-resonant state.

2. The gas absorption spectroscopy apparatus according to claim 1, wherein the resonator includes a plurality of mirrors and a piezoelectric element, and the controller is configured to apply a voltage to the piezoelectric element to displace positions of the plurality of mirrors.

3. A non-transitory computer readable medium where a control program is stored,
the control program being to be executed by a computer that is for use in a gas absorption spectroscopy apparatus for analyzing a sample, the gas absorption spectroscopy apparatus comprising:
a resonator configured to store the sample;
a light source configured to output a laser beam to the resonator;
an acousto-optic modulator disposed on an optical path between the light source and the resonator and configured to modulate a frequency of the laser beam according to a frequency of an input signal; and a photodetector configured to detect light output from the resonator,
the control program causing the computer to execute the steps of:
changing the frequency of the input signal to bring the laser beam in the resonator into a non-resonant state; and
measuring a target component in the sample using a signal detected by the photodetector while the laser beam in the resonator is in the non-resonant state.

4. A control method for use in a gas absorption spectroscopy apparatus for analyzing a sample,
the gas absorption spectroscopy apparatus comprising:
a resonator configured to store the sample;
a light source configured to output a laser beam to the resonator;
an acousto-optic modulator disposed on an optical path between the light source and the resonator and configured to modulate a frequency of the laser beam according to a frequency of an input signal; and a photodetector configured to detect light output from the resonator, the control method comprising, as processing executed by a computer, the steps of:
changing the frequency of the input signal to bring the laser beam in the resonator into a non-resonant state; and
measuring a target component in the sample using a signal detected by the photodetector while the laser beam in the resonator is in the non-resonant state.
